(19) United States
(12) Patent Application Publication
(10) Pub. No.: US 2019/0030653 A1
(43) Pub. Date: Jan. 31, 2019

(54) SOLDER RIBBON WITH EMBEDDED MESH FOR IMPROVED RELIABILITY OF SEMICONDUCTOR DIE TO SUBSTRATE ATTACHMENT

(71) Applicant: Indium Corporation, Utica, NY (US)

(72) Inventors: Seth Homer, Utica, NY (US); Craig Merritt, Utica, NY (US)

(21) Appl. No.: 16/132,393

(22) Filed: Sep. 15, 2018

Related U.S. Application Data
(62) Division of application No. 15/625,860, filed on Jun. 16, 2017.

(51) Int. Cl. B23K 35/02; B23K 1/00

(52) U.S. Cl. CPC B23K 35/0222; B23K 1/0008

(57) ABSTRACT

A solder ribbon with an embedded mesh for improved reliability of semiconductor die to substrate attachment is described. A solder ribbon is embedded with a mesh having a melting point greater than that of the solder. The mesh is embedded through substantially the entire area of the solder ribbon. The embedded solder ribbon may then be wound onto a spool. During a reflow soldering process, the ribbon on the spool may be cut into segments that are placed between a semiconductor die and substrate to which the semiconductor die is to be bonded. When the semiconductor assembly is heated, the solder melts, but the mesh does not, allowing for uniform bondline thickness control.

### CROSS-REFERENCE TO RELATED APPLICATIONS

This application is a divisional of U.S. application Ser. No. 15/625,860, filed on Jun. 16, 2017.

### TECHNICAL FIELD

The present disclosure relates generally to a solder for improving the reliability of a semiconductor die to substrate attachment and, in particular, a solder ribbon with an embedded mesh for improving the reliability of a semiconductor die to substrate attachment.

### DESCRIPTION OF THE RELATED ART

Large area solder joints in semiconductor devices can experience strain and cracking caused by large temperature variations when the semiconductor device is active. This problem is particularly prominent in solder joints with uneven bondline thickness (i.e., solder thickness) between the substrate and semiconductor component. This is illustrated by FIG. 1, which shows an uneven solder bondline thickness between a substrate and baseplate of an insulated-gate bipolar transistor (IGBT) module causing stress concentration at the thinner sections of the solder bond. Such an assembly is problematic as solder joint thickness is correlated with induced crack length after thermal cycling. This stress concentration at the thinner sections can cause delamination and premature failure of the electronic assembly during what should have been the operational life of the assembly.

The use of spacers in solder joints allows for the control of bondline thickness by creating a homogeneous bondline, which may increase the lifetime of a solder joint by allowing for inhomogeneous delamination caused by substrate tilt. One conventional spacer technique for achieving uniform bondline thickness is the use of wirebonds that are stitched and trimmed (to a required bondline) at the corners of the substrate/baseplate, followed by preform soldering. Such a method, however, has to factor in the costs associated with the additional process steps of wirebonding, trimming, and removal of the wirebond foot. Another conventional spacer technique for achieving uniform bondline thickness is the stamping of copper bumps on the copper baseplate. However, like the wirebonding technique, copper bump stamping has additional costs associated with the process steps of stamping the copper bumps.

### BRIEF SUMMARY

Embodiments described herein are directed to a solder ribbon with an embedded mesh for improving the reliability of a semiconductor die to substrate attachment.

In one embodiment, a solder assembly includes: a spool; and a solder ribbon wound around the spool, where the solder ribbon includes: a solder metal or metal alloy; and a mesh embedded through substantially the entire area of the solder ribbon, the embedded mesh including a plurality of substantially uniform interstitial spaces.

In implementations, the mesh may be a metallic mesh such as a copper mesh. In particular implementations, the liquidus temperature of the metallic mesh may be greater than 300° C., and the solidus temperature of the solder metal or metal alloy may be less than 300° C.

In some implementations, the solder ribbon is coated or embedded with flux. In some implementations, the solder metal or metal alloy is selected from the group consisting of: a tin-silver-copper (SAC) alloy, a tin (Sb) alloy, an Sb—Pb alloy, a high Pb alloy, an Indium (In) alloy, or In.

In one embodiment, a method of forming a solder assembly, includes: embedding a metallic mesh through substantially an entire area of a solder ribbon including a solder metal or metal alloy, where the embedded mesh includes a plurality of substantially uniform interstitial spaces; and after embedding the metallic mesh, winding the solder ribbon around a spool. In implementations, the method may further include: coating or embedding the solder ribbon with flux.

In one embodiment, a method of soldering, includes: cutting a segment of solder ribbon from a spool; placing the segment of solder ribbon between a substrate and a semiconductor component to form an assembly; and reflow soldering the assembly using a reflow soldering profile to form a solder joint, where the solder ribbon includes: a solder metal or metal alloy; and a mesh embedded through substantially the entire area of the solder ribbon, the embedded mesh including a plurality of substantially uniform interstitial spaces, where the solder metal or metal alloy melts during reflow soldering and where the mesh does not melt during reflow soldering. In implementations of this embodiment, the semiconductor component is an insulated-gate bipolar transistor (IGBT) chip.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The technology disclosed herein, in accordance with one or more various embodiments, is described in detail with reference to the included figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. Furthermore, it should be noted that for clarity and ease of illustration, the elements in the figures have not necessarily been drawn to scale.

FIG. 1 shows an uneven solder bondline thickness between a substrate and baseplate of an insulated-gate bipolar transistor (IGBT) module causing stress concentration at the thinner sections of the solder bond.

FIG. 2A illustrates a spool wound with a solder ribbon with an embedded mesh in accordance with embodiments.

FIG. 2B illustrates a segment of the embedded solder ribbon of FIG. 2A.

FIG. 2C is a close up perspective view illustrating an example structure of an embedded mesh that may be implemented in embodiments.

FIG. 3A is an operational flow diagram illustrating an example reflow soldering process that may be implemented using the embedded solder ribbon described herein.

FIG. 3B illustrates an example electronic assembly after process operations of FIG. 3A.

The figures are not intended to be exhaustive or to limit the disclosure to the precise form disclosed.

### DETAILED DESCRIPTION OF THE EMBODIMENTS

In accordance with various embodiments, a solder ribbon with an embedded mesh for improving the reliability of semiconductor die to substrate attachment is described. This may be implemented by embedding a solder ribbon with a mesh (e.g., a metallic, braided, woven, or expanded mesh) having a melting point greater than that of the solder. For example, the solder ribbon may be embedded with a copper, braided mesh. The mesh is embedded through substantially the entire area of the solder ribbon. The embedded solder ribbon may then be wound onto a spool. During a reflow soldering process, the ribbon on the spool may be cut into segments (i.e., preforms) that are placed between a semiconductor die and substrate to which the semiconductor die is to be bonded. When the semiconductor assembly is heated, the solder melts, but the mesh does not, allowing for uniform bondline thickness control.

Use of the disclosed solder ribbon with the embedded mesh during reflow soldering may provide several benefits. First, the solder ribbon may be used in high volume power electronics industry manufacturing. Second, the embedding of the mesh through substantially the entire solder ribbon area may eliminate or minimize the aforementioned die tilt problem by achieving a uniform bondline thickness. Third, the mesh improves the resistance of the solder to creep and delamination after long-term thermal cycling. Fourth, the geometry of the mesh may be adjusted according to the size of the area to be soldered to achieve a desired bondline thickness. Additionally, use of the solder ribbon with the embedded mesh offers an inexpensive form of bondline thickness control compared to traditional spacer technology as no additional steps, equipment, or features are needed during reflow soldering.

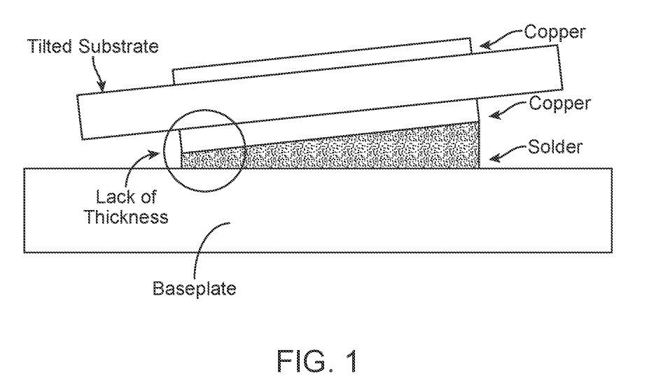

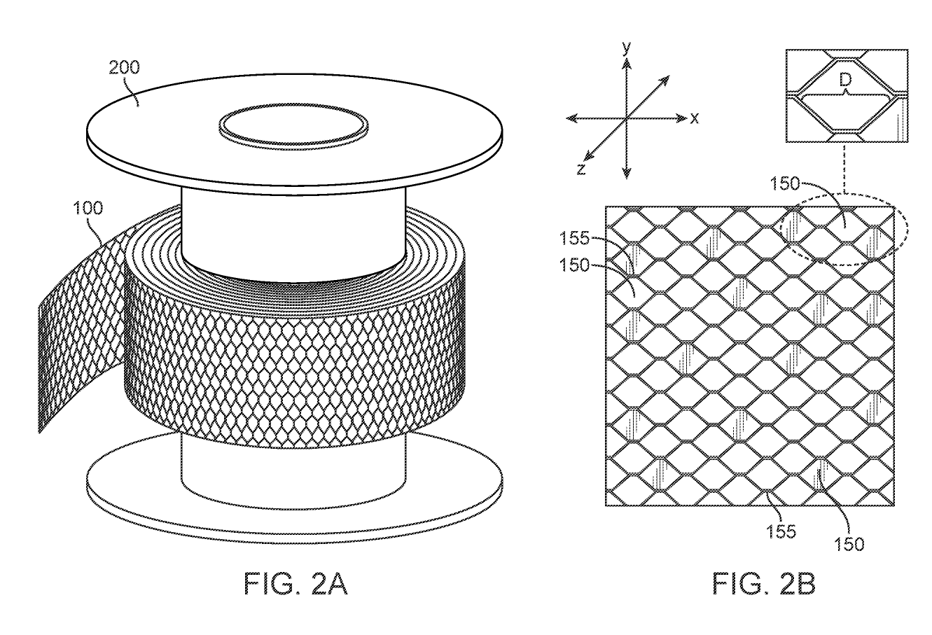

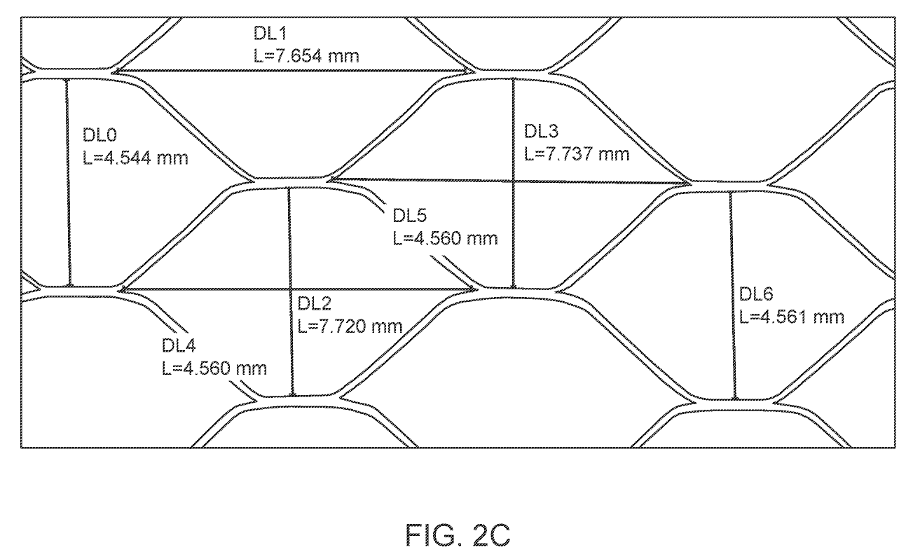

FIG. 2A illustrates a spool 200 wound with a solder ribbon with an embedded mesh 100 (referred to herein as an embedded solder ribbon) in accordance with embodiments. FIG. 2B illustrates a segment of embedded solder ribbon 100. As illustrated, the embedded solder ribbon is a substantially planar and long section of solder that may be cut from spool 200 in segments of desired length (x direction) during reflow soldering. For example, when fully wound on spool 200, the length (x direction) of embedded solder ribbon 100 may be at least a few meters, tens of meters, hundreds of meters, or even greater. In some implementations, not illustrated by FIG. 1A, a protective sheet such as a clear plastic may be placed over the surface of the embedded solder ribbon on the spool. The embedded solder ribbon may be dimensioned for a particular spool design and geometry. In this manner the embedded solder ribbon can be loaded on any spool design and geometry to fit any automated equipment.

In implementations, the embedded solder ribbon 100 may have a width (y direction) between about 0.030 inches and 4 inches. The width of embedded solder alloy ribbon 100 may be adjusted depending on the surface dimensions of the bonding site between the semiconductor and substrate. In implementations, the embedded solder ribbon 100 may have a thickness (z direction) between about 0.075 mm and 0.75 mm. Depending on the soldering application, the thickness of the embedded solder ribbon 100 (mesh and solder) may be adjusted to obtain a desired bondline thickness of a solder joint formed between the semiconductor and substrate.

As noted above, the mesh is embedded through substantially the entire area of the solder ribbon. The mesh is braided, woven, patterned, or otherwise fabricated from a material 155 having a high melting temperature (e.g., a solidus temperature of greater than 300 C). For example, the mesh may comprise a high melting point metal or metal alloy such as, for example, Copper (Cu), Silver (Ag), Gold (Au), Aluminum (Al), Nickel (Ni), or alloys thereof. Alternatively, in other implementations, the mesh may comprise a high melting point nonmetallic material such as polymer having high thermal stability. In a particular implementation, the mesh comprises greater than 90 wt % Cu.

Interstitial spaces 150 in the mesh may be substantially uniform in shape and dimension. As illustrated in this particular example, the interstitial spaces of the mesh are substantially hexagonal. However, the mesh need not necessarily be hexagonal. Depending on the soldering application, the dimensions of the area to be soldered, the elemental composition of the mesh, the elemental composition of the solder, or other considerations, the interstitial spaces of the mesh may comprise other geometric shapes. For example, the interstitial spaces may be shaped as polygons such that the mesh is rectangular, triangular, pentagonal, etc. Alternatively, the interstitial spaces may be shaped as ellipses (e.g., the mesh may be circular).

In implementations, the mesh may have a thickness between about 0.025 mm and 0.5 mm, and interstitial spaces 150 may have a maximum diameter (D) between about 0.25 mm and 20.32 mm. Depending on the soldering application, the thickness of the mesh may be varied to control for standoff thickness. FIG. 2C is a close up perspective view illustrating an example structure of an embedded mesh that may be implemented in embodiments.

With reference now to the solder, the solder of embedded solder alloy ribbon 100 may comprise any soft solder metal or metal alloy that may be formed into a ribbon and has a melting temperature range (solidus and liquidus temperature) suitable for the soldering application. For example, the solder may comprise a tin-silver-copper (SAC) alloy (e.g., SAC305), a tin (Sn) alloy, an Sb—Pb alloy, a high Pb alloy, an Indium (In) alloy, In, or other suitable metal alloy or metal. In implementations, the solder may have a liquidus temperature below 300 C. Prior to embedding the mesh, the solder ribbon may be rolled down to a precise thickness and cut to shape with precise control in the X-Y dimensions.

In some implementations, the solder ribbon may be coated with a solder flux (e.g., LV1000 flux coating) for use in an inert or ambient gas atmosphere during reflow soldering to promote wetting of the metal surfaces by molten solder. In other implementations the solder ribbon may be embedded with the solder flux.

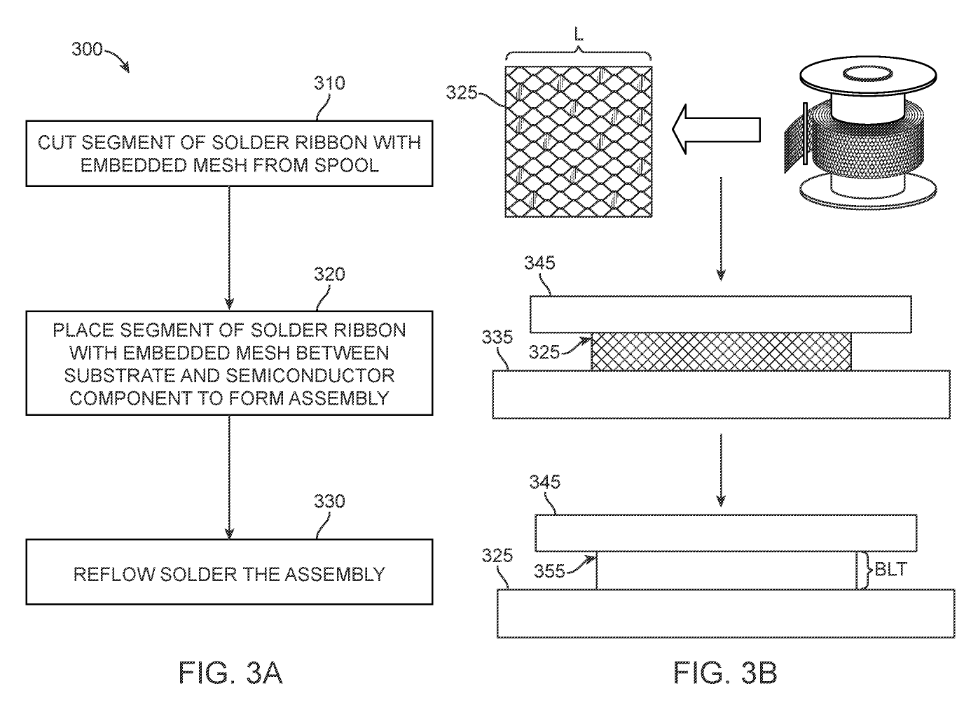

FIG. 3A is an operational flow diagram illustrating an example reflow soldering process 300 that may be implemented using the embedded solder ribbon described herein. FIG. 3A will be described concurrently with FIG. 3B, which illustrates an example electronic assembly (e.g., IGBT assembly) after various process operations of FIG. 3A. Prior to implementing process 300, the spool assembly of FIG. 1A may be created by forming a solder ribbon, embedding a mesh into the solder ribbon, and winding the embedded solder ribbon around the spool.

At operation 310, a segment of embedded solder ribbon 325 of predetermined length L is cut from the spool. In various embodiments, the length of the segment may depend on the dimensions of the bonding site (e.g., copper bonding site) between the substrate and the electronic component.

At operation 320, the segment of embedded solder ribbon 325 is placed (e.g., using a pick and place machine) between a semiconductor component 345 (e.g., semiconductor die or groups of dies) and metallic or metal coated substrate 335 to which it is to be bonded, thereby forming an assembly. For example, ribbon 325 may be placed between an IGBT chip and a direct bond copper (DBC) substrate including a ceramic tile and a sheet of copper.

At operation 330, the assembly is heated in a semiconductor reflow oven to melt the solder, which when cooled, solidifies, thereby bonding the semiconductor component 345 to the metal coated substrate 335, and forming solder joint 355 with uniform bond line thickness. During reflow, an intermetallic relationship may be established between the mesh and the bulk solder, resulting in a composite solder embedded mesh segment that increases the strength and creep resistance of the bulk solder. Additionally the mesh provides a “hard stop” uniformly over the bond line, preventing tilting of the semiconductor component, which minimizes areas of stress concentration due to varying bond line thicknesses.

In implementations, the assembly may be reflowed utilizing an inert gas or a forming gas atmosphere. Alternatively the assembly may be reflowed in a vacuum.

In some implementations, solder flux may be applied to the bonding site prior to oven reflow.

As used herein, the terms “about” and “substantially” are used to describe and account for small variations in a parameter. For example, in quantitative terms, the term “about” can refer to less than or equal to ±5%, less than or equal to ±2%, less than or equal to ±1%, less than or equal to ±0.5%, less than or equal to ±0.2%, less than or equal to ±0.1%, and less than or equal to ±0.05%. Moreover, where “about” is used herein in conjunction with a numerical parameter it is understood that the exact value of the numerical parameter is also contemplated and described. For example, the term “about 10” expressly contemplates, describes and includes exactly 10.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method of soldering, comprising:
cutting a segment of solder ribbon from a spool;
placing the segment of solder ribbon between a substrate and a semiconductor component to form an assembly; and
reflow soldering the assembly to form a solder joint,
wherein the solder ribbon comprises: a solder metal or metal alloy; and a mesh embedded through substantially the entire area of the solder ribbon, the embedded mesh comprising a plurality of substantially uniform interstitial spaces, wherein the solder metal or metal alloy melts during reflow soldering and wherein the mesh does not melt during reflow soldering.

2. The method of claim 1, wherein the semiconductor component is an insulated-gate bipolar transistor (IGBT) chip.

3. The method of claim 1, wherein the mesh is a metallic mesh.

4. The solder assembly of claim 3, wherein the mesh comprises copper.

5. The method of claim 3, wherein the liquidus temperature of the metallic mesh is greater than 300° C., and wherein the solidus temperature of the solder metal or metal alloy is less than 300° C.

6. The method of claim 1, wherein after reflow soldering the assembly, the embedded mesh provides a uniform bond line thickness between the semiconductor component and substrate, thereby preventing tilting of the semiconductor component.

7. The method of claim 1, wherein during reflow, an intermetallic relationship is established between the mesh and solder.

8. The method of claim 1, where the assembly is reflow soldered in an inert gas or a forming gas atmosphere.

9. The method of claim 1, further comprising: applying solder flux to a bonding site of the substrate and semiconductor component prior to reflow soldering.

10. The method of claim 1, wherein the semiconductor component is a semiconductor die.

11. The method of claim 10 wherein the segment of solder ribbon is placed on a metal of the substrate.

12. The method of claim 11, wherein a length of the segment of solder ribbon cut from the spool is based on dimensions of a bonding site between the substrate and semiconductor die.

13. The method of claim 1, wherein the solder ribbon is coated with flux.

14. The method of claim 1, wherein the solder ribbon is embedded with flux.

15. The method of claim 1, wherein the mesh comprises a polymer.

16. The method of claim 1, wherein the solder metal or metal alloy is selected from the group consisting of: a tin-silver-copper (SAC) alloy, a tin (Sn) (Sb) alloy, an Sb—Pb alloy, a high Pb alloy, an Indium (In) alloy, or In.
